(19) United States
(12) Patent Application Publication
(10) Pub. No.: US 2025/0326442 A1
(43) Pub. Date: Oct. 23, 2025

(54) COMPONENT FOR VEHICLE INTERIOR

(71) Applicant: Yanfeng International Automotive Technology Co. Ltd., Novi, MI (US)

(72) Inventors: Yiyun ZHANG, Shanghai (CN); Junwei ZHANG, Shanghai (CN); Jie SHI, Shanghai (CN); Ze JIN, Shanghai (CN)

(21) Appl. No.: 19/259,690

(22) Filed: Jul. 3, 2025

Related U.S. Application Data
(63) Continuation-in-part of application No. PCT/CN2023/141491, filed on Dec. 25, 2023.

(30) Foreign Application Priority Data
Jan. 3, 2023 (CN) 202310002472.X

(51) Int. Cl. B62D 25/14

(52) U.S. Cl. CPC B62D 25/145

(57) ABSTRACT

A component for a vehicle interior comprising a cross-beam structure such as for an instrument panel beam may comprise a beam body comprising driver side section (SCS) and center section (CS) and co-pilot section (PBS); set of brackets for the beam body may comprise a steering column section bracket (SCB) and center section bracket (CSB) for floor area and passenger section bracket (PBB); a bracket may comprise plastic material and/or a tubular structure; center section bracket may be connected to vehicle floor; passenger section bracket (PBB) may be configured to mount an airbag; cross-section of the tubular structure may comprise a circle, ellipse, rectangle, triangle, polygon or irregular shape and/or with reinforcing ribs. The beam body may comprise a metal beam member within a plastic beam member; the beam body may comprise a U-shape, a C-shape, a W-shape, a V-shape, Ω-shape, etc.

### CROSS-REFERENCE TO RELATED APPLICATIONS

The present application is a continuation-in-part of PCT/International Patent Application No. PCT/CN2023/141491 titled “INSTRUMENT PANEL BEAM AND VEHICLE COMPRISING THE BEAM” filed Dec. 25, 2023, which claims the benefit of Chinese Patent Application No. 202310002472.X titled “INSTRUMENT PANEL BEAM AND VEHICLE COMPRISING THE BEAM” filed Jan. 3, 2023.

The present application claims priority to and incorporates by reference in full: (1) PCT/International Patent Application No. PCT/CN2023/141491 titled “INSTRUMENT PANEL BEAM AND VEHICLE COMPRISING THE BEAM” filed Dec. 25, 2023; and (2) Chinese Patent Application No. 202310002472.X titled “INSTRUMENT PANEL BEAM AND VEHICLE COMPRISING THE BEAM” filed Jan. 3, 2023.

### FIELD

The present invention also relates to component for a vehicle interior configured to provide an instrument panel beam.

### BACKGROUND

It is known to provide a component such as an instrument panel beam for a vehicle interior.

It would be advantageous to provide a component such as an improved instrument panel beam comprising a beam body and a set of brackets.

It would be advantageous to provide a component such as an improved instrument panel beam comprising a beam body and a set of brackets comprising a plastic material and/or a tubular structure.

It would be advantageous to provide a component such as an improved instrument panel beam comprising a beam body comprising a plastic material and a set of brackets comprising a plastic material and/or a tubular structure.

### SUMMARY

The present invention relates to a component for a vehicle interior comprising a cross-beam structure comprising a beam body comprising an end (NS) and a steering column section (SCS) and a center section (CS) and a passenger section (PBS) and an end (NS); the component may comprise a set of brackets for the beam body comprising a steering column section bracket (SCB) and a center section bracket (CSBa) adjacent to the steering column section and a center section bracket (CSBb) at the center area and a center section bracket (CSBf) for a floor area and a passenger section bracket (PBB); at least one bracket of the set of brackets may comprise a plastic material; each of the set of brackets may comprise a plastic material; at least one bracket of the set of brackets may comprise a tubular structure; at least one bracket of the set of brackets may comprise a tube; at least one bracket of the set of brackets may comprise a hollow plastic tube; the steering column section bracket (SCB) may comprise a tubular structure; the center section bracket (CSBa) adjacent to the steering column section may comprise a tubular structure and the center section bracket (CSBf) for a floor area may comprise a tubular structure; the passenger section bracket (PBB) may comprise a tubular structure; the passenger section bracket (PBB) may comprise a set of passenger section brackets (PBB); at least one of the center section brackets may be configured to be connected to the front periphery in a vehicle body; a center section bracket (CSBf) for a floor area may be configured to be connected to a vehicle floor; a passenger section bracket (PBB) may be configured to mount a passenger side airbag; the tubular structure may comprise a cross-section comprising at least one of a circle, an ellipse, a rectangle, a triangle or a polygon; the tubular structure may comprise an irregular shape comprising concave features and/or convex features; the tubular structure may comprise reinforcing ribs; the center section bracket (CSBf) for the floor area may comprise a floor-connected bracket comprising a plastic tubular structure; the floor-connected bracket may be integrally formed with the beam body; the beam body may comprise a plastic beam member and a metal beam member within the plastic beam member; the beam body may comprise one or more of a U-shape, a C-shape, a W-shape, a V-shape or an Ω-shape; an end of at least one tubular structure of the set of brackets connected to the beam body may be angled toward a direction deviated from the beam body such that a hollow portion of the beam body may be independent of a hollow portion of the tubular structure; the component may comprise an instrument panel beam; the beam body may comprise a plastic beam member and a metal beam member embedded in the plastic beam member; the plastic beam member may be configured to be connected to a left-side periphery and a right-side periphery of a vehicle body; the metal beam member may be configured to be connected to at least one of the left-side periphery and the right-side periphery of the vehicle body; the beam body may comprise a metal beam member covered by a plastic beam member; a connection location of the beam body to at least one of the tubular structures in the plurality of brackets may be provided with a through hole aligned with the closed cross-section of the tubular structure; the beam body may comprise a tubular portion aligned with and integrally connected to at least one of the tubular structures in the plurality of brackets via the through hole; the beam body may comprise a plastic beam member and a metal beam member; the beam body may comprise a support provided at a connection location of a plastic beam member and at least one tubular structure of the set of brackets; the support passes through a metal beam member and may be provided between the metal beam member and a tubular portion of a plastic beam member; an end of at least one of tubular structure of the set of brackets connected to the beam body may be angled toward a direction deviated from the beam body such that the tubular structure may be connected to the beam body outside the closed cross-section; the beam body may comprise a plastic tube beam having a closed cross-section to form a hollow portion; a hollow portion of the beam body may be connected to a hollow portion of at least one tubular structure; an end of at least one tubular structure of the set of brackets away from the beam body may be provided with a connected projection for mounting a fastener; the steering column section bracket (SCB) may be configured to be connected to a front periphery and a steering column in a vehicle body; a metal beam of the beam body may be provided with a plurality of openings adapted for the passage of gas to form a plurality of recesses between a metal beam member and a tubular portion of a plastic beam member; the tubular structure may be formed by one of water-assisted injection molding, water-assisted injection molding with projectile, gas-assisted injection molding, and gas-assisted and water-assisted combined injection molding.

### FIGURES

FIG. 1A is a schematic diagram of a vehicle according to an exemplary embodiment.

FIG. 1B is a schematic diagram of an interior of a vehicle including a component shown as an instrument panel beam according to an exemplary embodiment.

FIG. 1C is a schematic perspective diagram of a component shown as an instrument panel beam according to an exemplary embodiment.

FIG. 2 is a schematic perspective diagram of a component shown as an instrument panel beam according to an exemplary embodiment.

FIG. 3 is an exploded schematic diagram of a component shown as an instrument panel beam according to an exemplary embodiment.

FIG. 4 is a front schematic diagram of a component shown as an instrument panel beam according to an exemplary embodiment.

FIG. 5 is a schematic cross-sectional diagram of the component according to an exemplary embodiment.

FIGS. 6A through 6C are partial enlarged schematic diagrams of the component according to an exemplary embodiment.

FIGS. 7A through 7C are partial enlarged schematic diagrams of the component according to an exemplary embodiment.

FIGS. 8A through 8C are partial enlarged schematic diagrams of the component according to an exemplary embodiment.

FIG. 9 is a front schematic diagram of a component comprising an instrument panel beam according to an exemplary embodiment.

FIG. 10 is a schematic cross-sectional diagram of the component according to an exemplary embodiment.

FIGS. 11A and 11B are partial enlarged schematic diagrams of the component according to an exemplary embodiment.

### DESCRIPTION

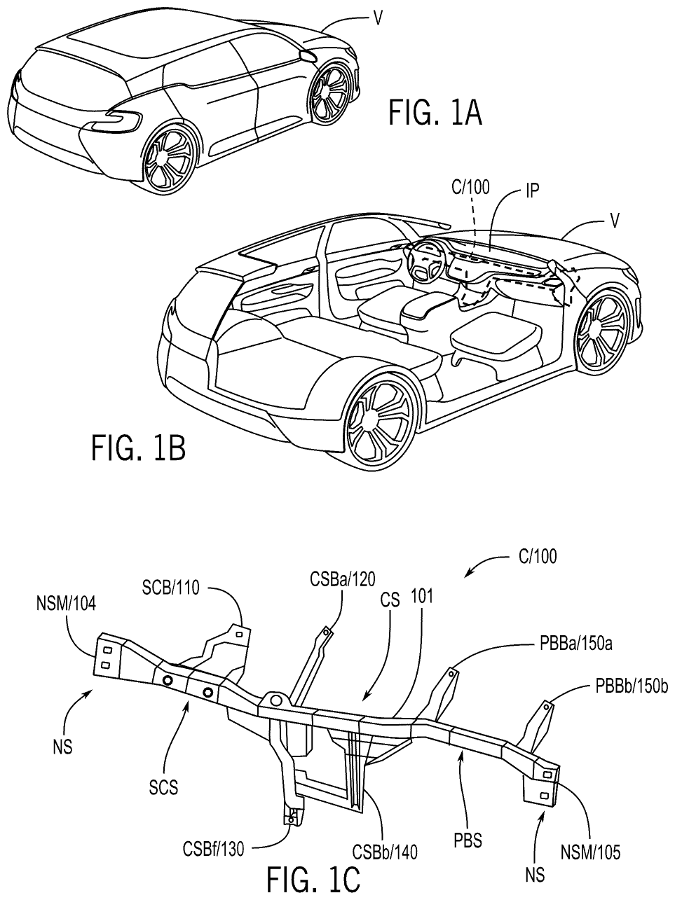

Referring to FIGS. 1A-1B, a vehicle V is shown with an interior comprising components including a component C shown as cross-beam structure configured to provide an instrument panel beam C/100.

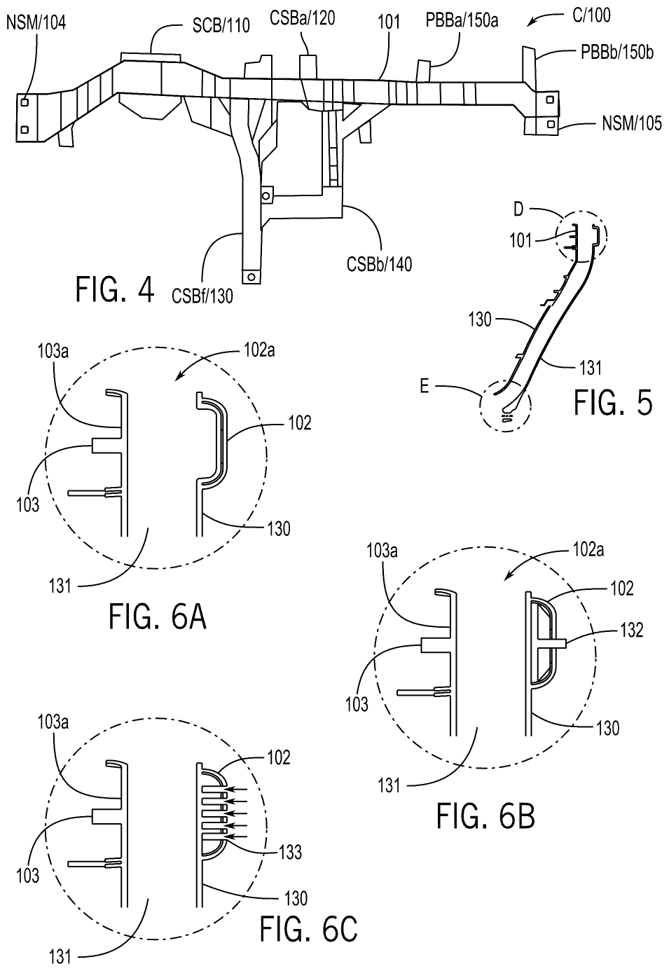

According to an exemplary embodiment as shown schematically in FIGS. 1C, 2, 3, 4 and 9, the component comprising a cross-beam structure comprises beam body comprising an end NS and a driving side section/steering column section SCS and a center section CS and a co-pilot section/passenger section PBS and an end NS; the component comprises a set of brackets for the beam body comprising a steering column section bracket SCB and a center section bracket CSBa adjacent to the steering column section and a center section bracket CSBb at the center area and a center section bracket CSBf for a floor area and a passenger section bracket PBB. As indicated schematically in the FIGURES, at least one bracket of the set of brackets may comprise a plastic material; each of the set of brackets may comprise a plastic material; at least one bracket of the set of brackets may comprise a tubular structure; at least one bracket of the set of brackets may comprise a tube; at least one bracket of the set of brackets may comprise a hollow plastic tube. See also FIGS. 5, 6A-6C, 7A-7C, 8A-C, 10 and 11A-11B.

As indicated schematically in FIGS. 1C, 2, 3, 4 and 9, the steering column section bracket SCB may comprise a tubular structure; the center section bracket CSBa adjacent to the steering column section may comprise a tubular structure and the center section bracket CSBf for a floor area may comprise a tubular structure; the passenger section bracket PBB may comprise a tubular structure; the passenger section bracket PBB may comprise a set of passenger section brackets; at least one of the center section brackets may be configured to be connected to the front periphery in a vehicle body; a center section bracket CSBf for a floor area may be configured to be connected to a vehicle floor; a passenger section bracket PBB may be configured to mount a passenger side airbag.

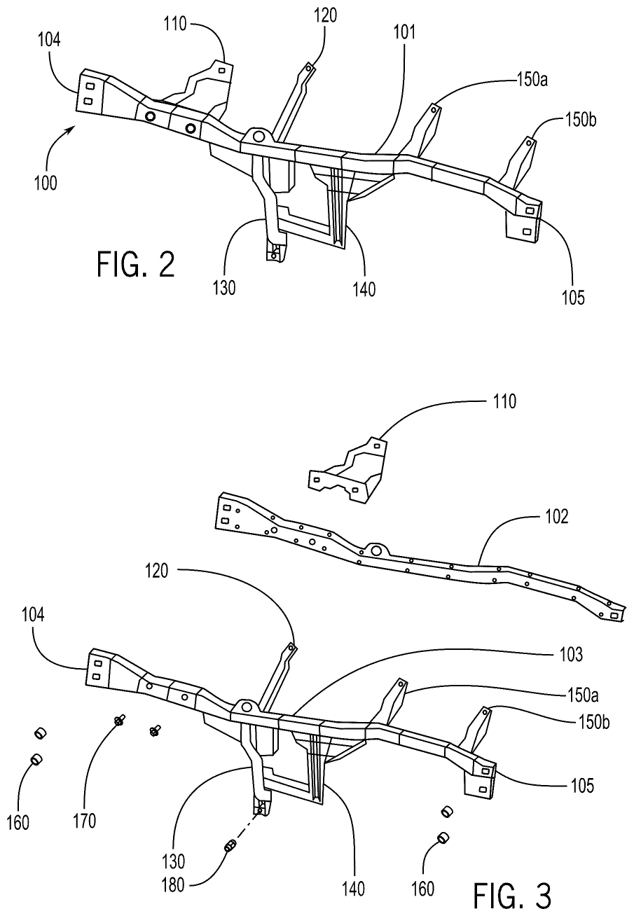

As indicated schematically in FIGS. 2, 3, 4, 5, 6A-6C, 7A-7C, 8A-C, 9, 10 and 11A-11B, the tubular structure of a bracket may comprise a cross-section comprising at least one of a circle, an ellipse, a rectangle, a triangle or a polygon; the tubular structure may comprise an irregular shape comprising concave features and/or convex features; the tubular structure may comprise reinforcing ribs; the center section bracket CSBf for the floor area may comprise a floor-connected bracket comprising a plastic tubular structure; the floor-connected bracket may be integrally formed with the beam body; the beam body may comprise a plastic beam member and a metal beam member within the plastic beam member; the beam body may comprise one or more of a U-shape, a C-shape, a W-shape, a V-shape or an Ω-shape; an end of at least one tubular structure of the set of brackets connected to the beam body may be angled toward a direction deviated from the beam body such that a hollow portion of the beam body may be independent of a hollow portion of the tubular structure.

As indicated schematically in FIGS. 1C, 2, 3, 4 and 9, the component may comprise an instrument panel beam; the beam body may comprise a plastic beam member and a metal beam member embedded in the plastic beam member; the plastic beam member may be configured to be connected to a left-side periphery and a right-side periphery of a vehicle body; the metal beam member may be configured to be connected to at least one of the left-side periphery and the right-side periphery of the vehicle body.

As indicated schematically in FIGS. 2, 3, 4, 5, 6A-6C, 7A-7C, 8A-C, 9, 10 and 11A-11B, the beam body of the component may comprise a metal beam member covered by a plastic beam member; a connection location of the beam body to at least one of the tubular structures in the plurality of brackets may be provided with a through hole aligned with the closed cross-section of the tubular structure; the beam body may comprise a tubular portion aligned with and integrally connected to at least one of the tubular structures in the plurality of brackets via the through hole; the beam body may comprise a plastic beam member and a metal beam member; the beam body may comprise a support provided at a connection location of a plastic beam member and at least one tubular structure of the set of brackets; the support passes through a metal beam member and may be provided between the metal beam member and a tubular portion of a plastic beam member; an end of at least one of tubular structure of the set of brackets connected to the beam body may be angled toward a direction deviated from the beam body such that the tubular structure may be connected to the beam body outside the closed cross-section; the beam body may comprise a plastic tube beam having a closed cross-section to form a hollow portion; a hollow portion of the beam body may be connected to a hollow portion of at least one tubular structure; an end of at least one tubular structure of the set of brackets away from the beam body may be provided with a connected projection for mounting a fastener.

As indicated schematically in FIGS. 2, 3, 4, 5, 6A-6C, 7A-7C, 8A-C, 9, 10 and 11A-11B, the steering column section bracket SCB may be configured to be connected to a front periphery and a steering column in a vehicle body metal beam of the beam body may be provided with a plurality of openings adapted for the passage of gas to form a plurality of recesses between a metal beam member and a tubular portion of a plastic beam member; the tubular structure may be formed by one of water-assisted injection molding, water-assisted injection molding with projectile, gas-assisted injection molding, and gas-assisted and water-assisted combined injection molding.

### Exemplary Embodiments—A

As indicated schematically in FIGS. 1A-1B, the vehicle V may comprise component C shown for an instrument panel IP to provide an instrument panel beam 100 (e.g. provided inside the instrument panel).

As indicated schematically in FIGS. 1C, 2, 3, 4 and 9, the instrument panel beam 100 may comprise a beam body 101 and a plurality of brackets provided on the beam body 101 for mounting and/or connection; the beam body 101 may comprise a first end 104 connected to a left-side periphery of a vehicle body V and a second end 105 connected to a right-side periphery of the vehicle body, the brackets extend from the beam body 101 between the first end 104 and the second end 105 of the beam body 101; at least one of the brackets is connected to the vehicle body (e.g. at least one of a floor, a front periphery, a steering column, a left-side periphery, and a right-side periphery of the vehicle body). As indicated schematically in the FIGURES, the connection of the bracket to the vehicle body may comprise direct connected to the vehicle body via fasteners (e.g., bolts), indirect connected to the vehicle body via other components, etc.

As indicated schematically in the FIGURES, the beam body 101 has a non-closed cross-section having a shape including, but not limited to, one or more of a U-shape, a C-shape, a W-shape, a V-shape, and an Ω-shape, and may comprise a plastic beam member 103 and a metal beam member 102 embedded in the plastic beam member 103; the beam body 101 comprises the metal beam member 102 and the plastic beam member 103 by insert injection molding. The plastic beam member 103 may comprise a first end 104 connected to the left-side periphery of the vehicle body and a second end 105 connected to the right-side periphery of the vehicle body, and the metal beam 102 may be connected to only one of the left-side periphery and the right-side periphery or may be connected to the left-side periphery and the right-side periphery, respectively. As indicated schematically in the FIGURES, the beam body may be an all-plastic beam member.

As indicated schematically in FIGS. 1C, 2, 3, 4 and 9, the brackets used for mounting and/or connection may include the first bracket 110, the second bracket 120, the third bracket 130, the fourth bracket 140, and the fifth bracket 150. The first bracket 110 is provided adjacent to the first end 104 of the beam body 101 and extends from the beam body 101 toward the front periphery, the first bracket 110 and the beam body 101 being bolted or insert injection molded for connection with the front periphery and the steering column. The second bracket 120 is provided adjacent to a central portion of the beam body 101 and extends from the beam body 101 toward the front periphery for connection with the front periphery. The third bracket 130 and the fourth bracket 140 are provided adjacent to the central portion of the beam body 101 and extend from the beam body 101 toward the center tunnel floor, and the third bracket 130 is closer to the first end 104 of the beam body 101 than the fourth bracket 140, where the third bracket 130 is used to connect with the center tunnel floor and support the central portion of the beam body 101, and the fourth bracket 140 may or may not be connected with the floor but is used to reinforce the instrument panel beam 100. The fifth bracket 150 is provided adjacent to the second end 105 of the beam body 101 and serves to mount the passenger side airbag. The third bracket 130 and the fourth bracket 140 may divide the instrument panel beam 100 into three sections: a driving side section on the left-side of the third bracket 130; a center section between the third bracket 130 and the fourth bracket 140; and a copilot side section on the right-side of the fourth bracket 140. As indicated schematically in the FIGURES, other corresponding brackets may also be provided depending on the actual installation and/or connection requirements. In addition, the instrument panel beam 100 also may comprise components for mounting or assembly, such as bushings 160, bolts 170, nuts 180, etc.

As indicated schematically in FIG. 5, the third bracket 130 (i.e., the floor-connected bracket) comprises plastic and is constructed in a tubular structure having a closed cross-section to form a hollow portion 131. As indicated schematically in the FIGURES, the third bracket 130 is integrally injection-molded with the plastic beam member 103, the hollow portion 131 of the third bracket 130 may be formed by one of water-assisted injection molding, water-assisted injection molding with projectile, gas-assisted injection molding, and gas-assisted and water-assisted combined injection molding. As indicated schematically in the FIGURES, in the injection molding process, the material inside the third bracket 130 is extruded to form the hollow portion 131 by using a high-pressure water flow, a water flow with a projectile, an air flow, or the like, whereby it is possible to overcome the drawback of the tubular structure having a closed cross-section that demolding is difficult to achieve in the conventional injection molding process. As indicated schematically in the FIGURES, several of the above-mentioned processes may be used primarily to form tubular structures having curved features in a plane or space; for linear tubular structures, this can also be achieved by using a core-pulling/sliding block in a conventional injection mold.

As indicated schematically in the FIGURES, the bracket forming the tubular structure having the closed cross-section is not limited to the third bracket 130; any of the brackets for mounting and/or connected may be formed by a variety of injection molding processes, etc. (according to other implementation variations). As indicated schematically in the FIGURES, at least one of the brackets is a plastic tubular bracket integrally formed with the plastic beam member 103; the material of the remaining brackets may be metal, plastic, or a combination of both. As indicated schematically in the FIGURES, a partial region of the metal beam 102 may be covered by the plastic beam member 103, parts of the first bracket 110, the second bracket 120, the third bracket 130, the fourth bracket 140, the fifth bracket 150, the bushings 160, the bolts 170, the nuts 180, the metal beam 102, and the plastic beam member 103 can be combined with each other through an insert injection molding process to form the entire instrument panel beam 100.

As indicated schematically in FIGS. 6A to 6C, different configurations of the instrument panel beam 100 may be provided for the connection location of the third bracket 130 and the beam body 101. As indicated schematically in FIG. 6A, both the inside and the outside of the metal beam member 102 having a substantially C-shaped cross-section are fitted with the plastic beam member 103 by insert injection molding; plastic beam member 103 is completely covered with the metal beam member 102 by insert injection molding. As indicated schematically in the FIGURES, the inner side of the metal beam member 102 may be fitted with the plastic beam member 103 by means of insert injection molding; the outer side of the metal beam member 102 is free of plastic material (e.g. the plastic beam member 103 may cover only the inner side of the metal beam member 102).

As indicated schematically in the FIGURES, at the connection location of the beam body 101 and the third bracket 130, the metal beam member 102 is provided at both upper and lower C-shaped side edges with through holes 102a aligned with the closed cross-section of the third bracket 130; the plastic beam member 103 may comprise a tubular portion 103a aligned with and integrally connected to the third bracket 130 through the through holes 102a. As indicated schematically in the FIGURES, an upper opening of the third bracket 130 is aligned with a lower opening of the tubular portion 103a via the through hole 102a; the third bracket 130 and the tubular portion 103a form a hollow structure. As indicated schematically in the FIGURES, the metal beam member 102 may extend partially (not fully) in the transverse direction to the connection location of the beam body 101 with the third bracket 130 (e.g. the beam body 101 may not be provided with a metal material at the connection location with the third bracket 130, but only with a plastic material including the tubular portion 103a). As indicated schematically, the upper end of the third bracket 130 connected to the beam body 101 may be arranged to be angled/bent in a direction deviating from the beam body 101, so that the upper end of this third bracket 130 is connected to the plastic beam member 103 outside the closed cross-section of this third bracket 130 (e.g. without 102a and the tubular portion 103a).

As indicated schematically in FIG. 6B, in the connection location of the beam body 101 with the third bracket 130, the beam body 101 also may comprise a support 132 (e.g. a support configured with a T-shape form passing through the metal beam member 102 and arranged between the inner side of the metal beam member 102 and the outer side of the tubular portion 103a of the plastic beam member 103, so that a more uniform wall thickness can be obtained for this tubular portion 103a upon injection molding); the support 132 may be pre-mounted and fixed to the metal beam 102 prior to the insert injection molding (e.g. to enhance the local rigidity of the metal beam 102 and to prevent the inside of the metal beam 102 from being filled with too much plastic during the forming of the tubular portion 103a and to reduce the cooling time and the weight of the product/component).

As indicated schematically in FIG. 6C, the metal beam 102 may be provided with a plurality of openings 133 for the passage of gas to form a plurality of recesses between the inner side of the metal beam 102 and the outer side of the tubular portion 103a of the plastic beam member 103 at the connection location of the beam body 101 and the third bracket 130; in the insert injection molding process, the inner side of the metal beam 102 may be filled with a plastic material while gas is injected inwardly through these openings 133, so that a honeycomb-like structure may be formed between the inner side of the metal beam 102 and the outer side of the tubular portion 103a; the weight of the product can be reduced while satisfying the rigidity requirements of the beam body.

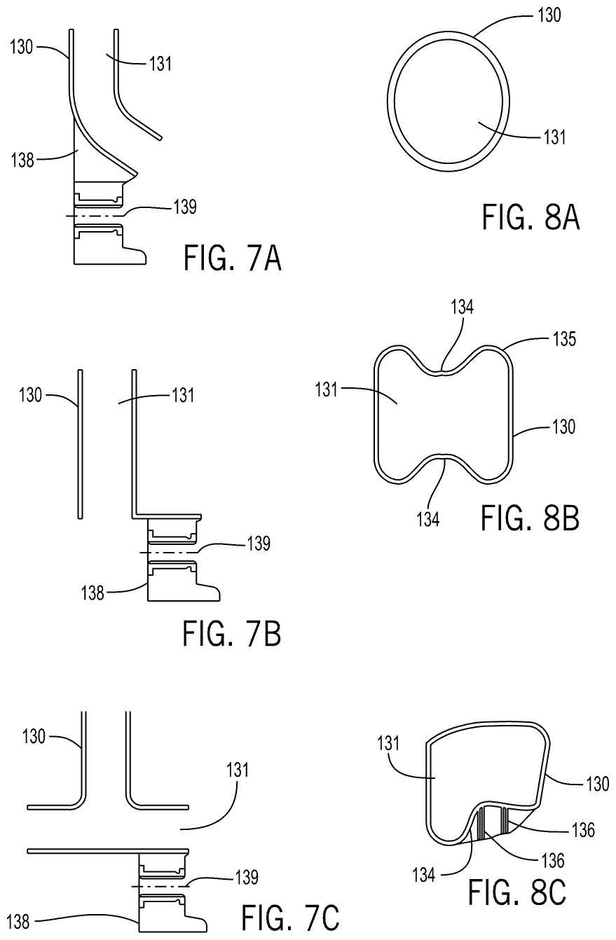

As indicated schematically in FIGS. 7A to 7C, configurations of the instrument panel beam 100 at the connection location of the third bracket 130 with a center tunnel floor (not shown) may be provided; the lower end of the third bracket 130 away from the beam body 101 may be provided with a connection projection 138 projecting downward for mounting a fastener; the connection projection 138 may be provided with a connection hole 139 for connecting the third bracket 130 to the center tunnel floor by a bolt passing through the connection hole 139.

As indicated schematically in FIG. 7A, the lower end of the third bracket 130 may be angled/bent in a direction deviated from the connection point of the third bracket 130 with the center tunnel floor; the connected projection 138 projecting downward may be provided outside the closed cross-section of the third bracket 130. As indicated schematically in FIG. 7B, the third bracket 130 may be rectilinear above the connection point and may comprise a connection flange 130a extending laterally for providing the connected projection 138. As indicated schematically in FIG. 7C, the hollow portion 131 of the third bracket 130 may be divided into two paths opened toward both sides above the connection point (e.g. the third bracket 130 may comprise a lateral section 130b located at the bottom of the third bracket 130 and provided with a connected projection 138 at the outside to enhance the self-rigidity of the third bracket 130. As indicated schematically, configurations of the lower end of the third bracket may be selected according to the manufacturing process of the product and the assembly space requirements.

As indicated schematically in FIGS. 8A to 8C, cross-sectional shapes of the third bracket 130 of the instrument panel beam 100 may be provided in different configurations. As indicated schematically in FIG. 8A, the shape of the closed cross-section of the third bracket 130 may be configured in a regular geometric figure (e.g. circular, elliptical, rectangular, triangular, polygonal, etc. shapes). As indicated schematically in FIG. 8B, the shape of the closed cross-section of the third bracket 130 may be provided as an irregular shape (e.g. with recessed features 134 in one or more directions, for reducing in size to provide more design space for other components mounted adjacent to the third bracket 130); a protruding feature 135 may be provided at the perimeter of the recessed feature 134 for increasing the stiffness and strength of the third bracket 130 (e.g. in a selected/design direction). As indicated schematically in FIG. 8C, the third bracket 130 may comprise a plurality of reinforcing ribs 136 provided at least partially outside the closed cross-section of the third bracket; a plurality of reinforcing ribs 136 may be provided outside the irregular cross-section recessed features 134 (e.g. for increasing the stiffness of the third bracket 130, partially or entirely).

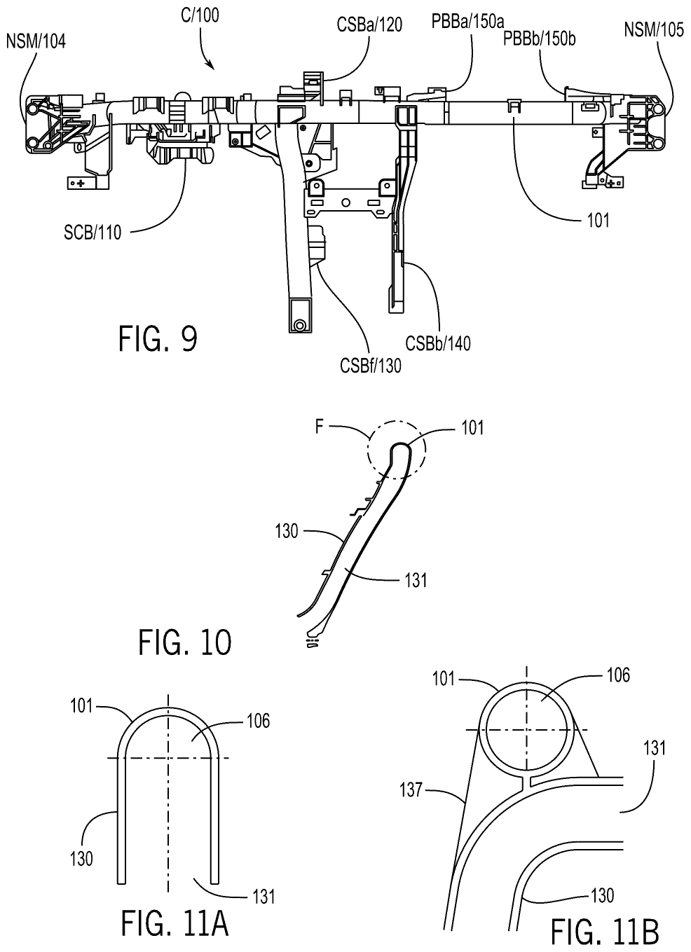

As indicated schematically in FIGS. 9, 10 and 11A-11B, an instrument panel beam 100 may comprise (in overall construction) the beam body 101 comprising material entirely of plastic and constructed as a tubular beam having a closed cross-section to form a hollow portion; the tubular beam may be formed integrally with the third bracket 130 forming the tubular structure (e.g. by water-assisted injection molding, water-assisted injection molding with projectile, gas-assisted injection molding, gas-assisted and water-assisted combined injection molding, etc.).

As indicated schematically in FIGS. 11A and 11B, configurations of the instrument panel beam 100 may comprise variations of the connection location of the third bracket 130 and the beam body 101. As indicated schematically in FIG. 11A, the third bracket 130 may be perpendicularly connected to the beam body 101 through the upper end (e.g. with continuity of the hollow portion 106 of the beam body 101 and the hollow portion 131 of the third bracket 130). As indicated schematically, the hollow portion 106 of the beam body 101 and the hollow portion 131 of the third bracket 130 may be co-molded by injection molding processes, etc.

As indicated schematically in FIG. 11B, the upper end of the third bracket 130 (connected to the beam body 101) may be arranged to be angled/bent toward a direction deviated from the beam body 101; the hollow portion 106 of the beam body 101 and the hollow portion 131 of the third bracket 130 are independent (e.g. do not communicate). As indicated schematically, the third bracket 130 and the beam body 101 may be connected to each other by a reinforcing rib 137; the hollow portion 131 of the third bracket 130 and the hollow portion 106 of the beam body 101 may be separately formed; the third bracket 130 and the beam body 101 may be designed to have different wall thicknesses.

As indicated schematically in the FIGURES, the instrument panel beam 100 may comprise the beam body 101; by designing at least one bracket for mounting and/or connection extending from the beam body 101 as a tubular structure having a closed cross-section (e.g. relatively simple to manufacture), the instrument panel beam 100 may be provide rigidity and strength requirements with reduced weight/mass (e.g. to achieve the effect of reducing the amount of carbon emission during production and use of the vehicle).

### Exemplary Embodiments—B

As indicated schematically, a component shown as an instrument panel beam may comprise at least one plastic bracket for the instrument panel crossbeam with suitable mechanical properties and ease to manufacture (e.g. less expensive to manufacture and with reduced volume and weight). The beam body may comprise a first end and a second end, the first end and the second end being adapted to be connected to a left-side periphery and a right-side periphery of a vehicle body, respectively; and a plurality of brackets extending from the beam body between the first end and the second end, and at least one of the plurality of brackets being adapted to be connected with the vehicle body, at least one of the plurality of brackets comprises plastic and is configured as a tubular structure having a closed cross-section to form a hollow portion.

As indicated schematically in the FIGURES, the plurality of brackets may comprise a first bracket provided adjacent to the first end of the crossbeam body; the first bracket may be adapted to be connected to a front periphery and a steering column of the vehicle body.

As indicated schematically in the FIGURES, the plurality of brackets may comprise a second bracket provided adjacent to a central portion of the beam body; the second bracket is adapted to be connected to the front periphery of the vehicle body.

As indicated schematically in the FIGURES, the plurality of brackets may comprise a third bracket and a fourth bracket provided adjacent to a central portion of the beam body; the third bracket and the fourth bracket may be adapted to extend toward a floor of the vehicle body; at least one of the third bracket and the fourth bracket may be adapted to be connected to the floor. As indicated schematically in the FIGURES, the plurality of brackets may comprise a fifth bracket provided at a second end of the beam body and adapted to mount a passenger side airbag.

As indicated schematically, the closed cross-section of the tubular structure may be shaped as a geometric figure including one of a circle, an ellipse, a rectangle, a triangle, and a polygon; the shape of the closed cross-section of the tubular structure may be an irregular shape with concave and/or convex features. As indicated schematically, the shape of the non-closed cross-section of the beam body may comprise one or more of a U-shape, a C-shape, a W-shape, a V-shape, an Ω-shape, etc. At least a partial area of the metal beam member may be covered by the plastic beam member. As indicated schematically, the tubular structure may comprise reinforcing ribs provided in at least a partial area outside the closed cross-section.

As indicated schematically, the plurality of brackets may comprise a floor-connected bracket provided adjacent to a central portion of the beam body; the floor-connected bracket may be adapted to connect to a floor of the vehicle body and support the central portion of the beam body; the floor-connected bracket may be made of plastic and configured in the tubular structure; the floor-connected bracket may be integrally formed with the beam body. As indicated schematically, the beam body may comprise a non-closed cross-section and may comprise a plastic beam member and a metal beam member embedded in the plastic beam member; the plastic beam member may be adapted to be connected to a left-side periphery and a right-side periphery of the vehicle body, respectively, and the metal beam member may be adapted to be connected to at least one of the left-side periphery and the right-side periphery of the vehicle body; a connection location of the beam body to at least one of the tubular structures in the plurality of brackets is provided with a through hole aligned with the closed cross-section of the tubular structure; the beam body may comprise a tubular portion aligned with and integrally connected to at least one of the tubular structures in the plurality of brackets via the through hole.

As indicated schematically, the beam body may comprise a support provided at a connection location of the plastic beam member and at least one of the tubular structures in the plurality of brackets; the support may pass through the metal beam member and may be provided between the metal beam member and the tubular portion of the plastic beam member.

As indicated schematically in the FIGURES, the tubular structure may be formed by one of water-assisted injection molding, water-assisted injection molding with projectile, gas-assisted injection molding, and gas-assisted and water-assisted combined injection molding. As indicated schematically, the metal beam may be provided with a plurality of openings adapted for the passage of gas to form a plurality of recesses between the metal beam and the tubular portion of the plastic beam member.

As indicated schematically, an end of at least one of the plurality of brackets connected to the beam body may be angled/bent toward a direction deviated from the beam body such that the tubular structure is connected to the beam body outside the closed cross-section.

As indicated schematically, the beam body may comprise plastic and may be configured as a tube beam having a closed cross-section to form a hollow portion; the hollow portion of the beam body may be connected to the hollow portion of at least one of the tubular structures of the plurality of brackets.

As indicated schematically, an end of at least one of the plurality of brackets connected to the beam body may be angled/bent toward a direction deviated from the beam body such that the hollow portion of the beam body and the hollow portion of the tubular structure are independent from each other; an end of at least one of the tubular structures in the plurality of brackets away from the beam body may be provided with a connected projection for mounting a fastener.

### Exemplary Embodiments—C

As indicated schematically in the FIGURES, the component shown as instrument panel beam may be configured to provide advantageous features; the design form of at least one plastic bracket extending from the beam body may be improved to be constructed into a tubular structure with a closed cross-section; weight can be reduced while satisfying the rigidity requirements; the effect of reducing the carbon emission during production and use can be achieved; the instrument panel beam is simple in structure, occupies a small space, and has a low manufacturing cost and can be widely used in various types of vehicles.

In recent years, with the vigorous development of new energy vehicles and the urgent global demand for carbon emission reduction, vehicle light-weighting has become a focus area in the design and development processes of main engine plants and supporting suppliers. Traditional instrument panel beam products are predominantly constructed from metallic materials such as structural steel or aluminum alloys. As a structural component in vehicles, the instrument panel beam not only supports interior trim parts including the instrument panel and center console but also provides a certain degree of passenger protection during collisions; unlike ordinary decorative components the instrument panel beam component must meet stringent requirements in terms of modal characteristics, stiffness, and strength.

As indicated schematically in the FIGURES, the component shown as instrument panel beam may comprise a first end and a second end; the first end and the second end may be adapted to be connected to a left-side periphery and a right-side periphery of a vehicle body; a plurality of brackets may extend from the beam body between the first end and the second end; at least one of the plurality of brackets may be adapted to be connected with the vehicle body; at least one of the plurality of brackets may comprise plastic and may be configured as a tubular structure having a closed cross-section to form a hollow portion; the at least one plastic bracket of the instrument panel beam may comprise mechanical properties and provide for ease of manufacture and provide for an instrument panel beam less expensive to manufacture and with reduced volume and weight.

TABLE A
REFERENCE SYMBOL LIST

| REFERENCE | ELEMENT, |
|---|---|
| SYMBOL | PART OR COMPONENT |
| V | Vehicle |
| IP | Instrument Panel |
| C | Component |
| NS | End section |
| SCS | steering column section/driving side section |
| CS | center section |
| PBS | passenger section/co-pilot section |
| SCB | steering column section bracket |
| CSB | center section bracket |
| PBB | passenger section bracket |
| NSM | end |
| 100 | Instrument panel beam |
| 101 | Beam body |
| 102 | Metal beam member |
| 102a | Through holes |
| 103 | Plastic beam member |
| 103a | Tubular portion |
| 104/NSM | First end |
| 105/NSM | Second end |
| 106 | Hollow portion |
| 110/SCB | First bracket (steering column section bracket) |
| 120/CSBa | Second bracket (center section bracket) |
| 130/CSBf | Third bracket (center section bracket) |
| 130a | Connection flange |
| 130b | Lateral section |
| 131 | Hollow portion |
| 132 | Support |
| 133 | Openings |
| 134 | Recessed features |
| 135 | Protruding feature |
| 136 | Reinforcing ribs |
| 137 | Reinforcing rib |
| 138 | Connected projection |
| 139 | Connection hole |
| 140/CSBb | Fourth bracket (center section bracket) |
| 150/PBB | Fifth bracket (passenger section bracket) |
| 160 | Bushings |
| 170 | Bolts |
| 180 | Nuts |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component for a vehicle interior comprising;
a cross-beam structure comprising a beam body comprising an end (NS) and a steering column section (SCS) and a center section (CS) and a passenger section (PBS) and an end (NS);
a set of brackets for the beam body comprising a steering column section bracket (SCB) and a center section bracket (CSBa) adjacent to the steering column section and a center section bracket (CSBb) at the center area and a center section bracket (CSBf) for a floor area and a passenger section bracket (PBB);
wherein at least one bracket of the set of brackets comprises a plastic material.

2. The component of claim 1 wherein each of the set of brackets comprises a plastic material.

3. The component of claim 1 wherein at least one bracket of the set of brackets comprises a tubular structure.

4. The component of claim 1 wherein at least one bracket of the set of brackets comprises a tube.

5. The component of claim 1 wherein at least one bracket of the set of brackets comprises a hollow plastic tube.

6. The component of claim 1 wherein the steering column section bracket (SCB) comprises a tubular structure.

7. The component of claim 1 wherein the center section bracket (CSBa) adjacent to the steering column section comprises a tubular structure and the center section bracket (CSBf) for a floor area comprises a tubular structure.

8. The component of claim 1 wherein the passenger section bracket (PBB) comprises a tubular structure.

9. The component of claim 1 wherein the passenger section bracket (PBB) comprises a set of passenger section brackets (PBB).

10. The component of claim 1 wherein at least one of the center section brackets is configured to be connected to the front periphery in a vehicle body.

11. The component of claim 1 wherein a center section bracket (CSBf) for a floor area is configured to be connected to a vehicle floor.

12. The component of claim 1 wherein a passenger section bracket (PBB) is configured to mount a passenger side airbag.

13. The component of claim 3 wherein the tubular structure comprises a cross-section comprising at least one of a circle, an ellipse, a rectangle, a triangle or a polygon.

14. The component of claim 1 wherein the tubular structure comprises an irregular shape comprising concave features and/or convex features.

15. The component of claim 1 wherein the tubular structure comprises reinforcing ribs.

16. The component of claim 1 wherein the center section bracket (CSBf) for the floor area comprises a floor-connected bracket comprising a plastic tubular structure.

17. The component of claim 10 wherein the floor-connected bracket is integrally formed with the beam body.

18. The component of claim 1 wherein the beam body comprises a plastic beam member and a metal beam member within the plastic beam member.

19. The component of claim 18 wherein the beam body comprises one or more of a U-shape, a C-shape, a W-shape, a V-shape or an Ω-shape.

20. The component of claim 3 wherein an end of at least one tubular structure of the set of brackets connected to the beam body is angled toward a direction deviated from the beam body such that a hollow portion of the beam body is independent of a hollow portion of the tubular structure.
